(19) United States
(12) Patent Application Publication
(10) Pub. No.: US 2014/0025696 A1
(43) Pub. Date: Jan. 23, 2014

(54) Method, Program and System for Generating RDF Expressions

(71) Applicant: International Business Machines Corporation, Armonk, NY (US)

(72) Inventors: Shunichi Amano, Kanagawa (JP); Hisashi Miyashita, Kanagawa-ken (JP); Hiroaki Nakamura, Kanagawa-ken (JP); Hideki Tai, Nerima-ku (JP)

(21) Appl. No.: 13/941,668

(22) Filed: Jul. 15, 2013

(30) Foreign Application Priority Data
Jul. 20, 2012 (JP) 2012-162030

(51) Int. Cl. G06F 17/30

(52) U.S. Cl. CPC G06F 17/30569
USPC 707/756

(57) ABSTRACT

A system and method of generating RDF expression. The system receives a URI from a tool using linked data, and identifies an object to become a seed from the URI. Next, the appropriate mapping file is identified from the type of object, and type information is generated from this. The generated type information is referenced, and objects are collected following recursively from the seed. The system sends a graph of the collected objects to an RDF converter. The RDF converter references the mapping file, and converts the object graph into RDF, which is then outputted.

### CROSS-REFERENCE TO RELATED APPLICATION

This application claims priority under 35 U.S.C. §119 from Japanese Patent Application No. 2012-162030 filed Jul. 20, 2012, the entire contents of which are incorporated herein by reference.

### BACKGROUND OF THE INVENTION

1. Field of the Invention

The present invention relates to a method, program and system for generating RDF expressions from predetermined data using computer processing.

2. Description of Related Art

In recent years, the Resource Description Framework (RDF) format has been used as a mechanism for describing resources on the web, as described in Japanese Laid-open Patent Application No. 2005-242934 and Japanese Laid-open Patent Application No. 2006-302085. Also, linked data using RDF formatted data in a web mechanism serving as a mechanism for global information disclosure has been described in Christian Bizer, Tom Heath, Tim Berners-Lee, Linked Data—The Story So Far, International Journal on Semantic Web and Information Systems, 5 (3), 2009. In addition, Open Services for Lifecycle Collaboration (OSLC) and http://open-services.net/describe the use of linked data for in-house information coordination.

Tools that provide linked data include tools that store and provide RDF data, and tools that both manage existing tools and convert non-RDF data to RDF, which is then provided.

Tools that use linked data also include tools that obtain data by linking based on user requests and tools that crawl over tools that provide linked data beforehand to create an index in order to make data access more efficient.

FIG. 1 is a diagram showing an example of a configuration in which a plurality of computers is connected via a network in order to use this type of tool. In other words, computers 104, 106, 108, 110, 112, 114, 116, and 118 are connected to a network 102 which is typically a LAN or WAN. Computer 104 and computer 110 include a tool that stores and provides RDF data.

Computer 106 and computer 112 include an existing tool. Here, data that is handled by an existing tool references records that are stored in a relational database and structured data such as objects, XML, HTML, CSV in an application descriptive language that is accessed by the API of an existing tool.

Computer 108 and computer 114 include a tool that manages the existing tools in computer 106 and computer 112, and converts non-RDF data to RDF which is then provided. In other words, a tool is stored that converts and provides linked data.

Computer 116 stores a tool that obtains data via linking based on user requests. Computer 118 stores a tool that crawls over tools that provide linked data beforehand to create an index.

As shown in FIG. 1, the objects of each application have to be converted as RDF in order to associate a number of applications to linked data.

One well-known technique of the prior art has the configuration summarized in FIG. 2. In this configuration, the entire object repository 202 is converted statically to RDF 204. In this configuration, the corresponding RDF 210 is returned in response to a query by URI 208 from the tool using linked data 206. However, when some of the object repository 202 is updated in this configuration, the entire object repository 202 has to be converted to RDF 204 over again, which is inefficient.

A well-known technique of the prior art improving upon this has the configuration summarized in FIG. 3. In this configuration, a URI 304 is received from a tool using linked data 302, an API call 306 is performed, and there is code 310 to access the object repository 308. The action of this code 310 extracts an object 312 from the object repository 308. An RDF converter 314 references mapping files 316, and RDF 318 is generated and sent to the tool using linked data 302. A description of one of these API calls 306 can be found at http://jena.sourceforge.net/tutorial/RDF_API/. A mapping file is a file defining RDF conversion rules such as dependencies and hierarchies. However, when the RDF specifications are changed and the necessary objects are changed in this configuration, the code 310 for accessing the repository inevitably has to be changed. When the objects are complicated and have, for example, a large number of properties, changing the code 310 is susceptible to problems such as bugs.

### SUMMARY OF THE INVENTION

In one aspect of the invention, a computer implemented method for converting URI to RDF is provided. The method includes receiving a URI, identifying an object to become a seed from the URI, generating type information from the type of the object in a mapping file, collecting the necessary objects from an object repository by referencing the generated type information, passing the collected objects to an RDF converter, and having the RDF converter reference the information of the mapping file to convert the collected objects to RDF.

In a second aspect of the invention, a non-transitory computer readable storage medium tangibly embodying a computer readable program code having computer readable instructions which, when implemented, cause a computer to carry out the steps of a method for converting URI to RDF is provided. The method includes receiving a URI, identifying an object to become a seed from the URI, generating type information from the type of the object in a mapping file, collecting the necessary objects from an object repository by referencing the generated type information, passing the collected objects to an RDF converter, and having the RDF converter reference the information of the mapping file to convert the collected objects to RDF.

In a third aspect of the invention a computer implemented system for converting URI to RDF. The system includes a storage means, an object repository stored in the storage means, a mapping file including a pattern of the RDF to be generated, and the types, names, and property names of the objects needed for RDF generation, an RDF converter stored in the storage means, means for receiving a URI and identifying an object to become a seed from the URI, means for generating type information from the type of the object in a mapping file, means for collecting the necessary objects from the object repository by referencing the generated type information, and means in the RDF converter for referencing the information of the mapping file to convert the collected objects to RDF.

### BRIEF DESCRIPTION OF THE DRAWINGS

FIG. 1 is an overview of a system configuration comprising a plurality of network-connected computers including a tool for converting and providing linked data, and a tool using linked data.

FIG. 2 is a diagram showing a prior art technique used to provide RDF corresponding to a URI.

FIG. 3 is a diagram showing another prior art technique used to provide RDF corresponding to a URI.

FIG. 4 is a block diagram of a hardware configuration used to embody the present invention.

FIG. 5 is a block diagram of the functional elements used to embody the present invention.

FIG. 6 is a flowchart of processing used to embody the present invention.

FIG. 7 is a flowchart of processing used to embody the present invention.

FIGS. 8(a) and 8(b) are diagrams showing an example of type information generated from a mapping file.

FIG. 9 is a diagram showing an outline of all of the processing performed in the present invention.

### DETAILED DESCRIPTION OF THE PREFERRED EMBODIMENTS

The following is an explanation of embodiments of the present invention with reference to the drawings. The embodiments of the present invention are used to explain the best mode of carrying out the present invention, and are not intended to limit the scope of the present invention in any way. In all of the drawings, identical objects are denoted by the same reference numbers unless otherwise indicated.

The present invention was inspired by the generation of type information from a mapping file created only during RDF conversion. A process is performed to reference the generated type information and recursively collect objects from seed objects.

More specifically, the system of the present invention performs the following processing.
(1) The system receives a URI from, for example, a tool using linked data.
(2) The system identifies an object that will be a seed from the URI. Next, the appropriate mapping file is identified from the type of the object, and (some) type information is generated from this. This process is possible because known information such as the names and types of objects needed for RDF generation, property names, and relationships between types is embedded in mapping files.
(3) Next, the system references the generated type information and collects objects following recursively from the seed.
(4) Next, the system returns a graph of the collected objects to the RDF converter.
(5) The RDF converter references the mapping file, converts the object graph to RDF, which is then outputted.

In the present invention, type information is generated from a mapping file, objects are collected using this type information, and a graph of the collected objects is converted to RDF. In this way, specification changes to, for example, an object repository can be supported with a minimal amount of effort.

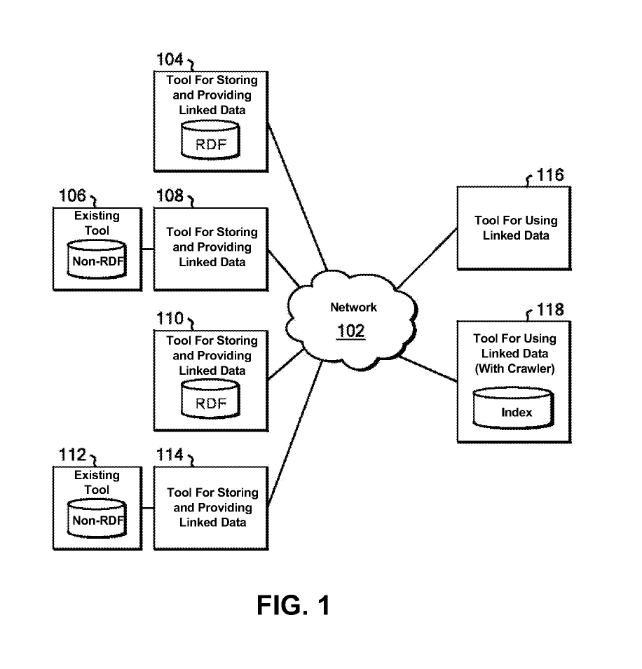

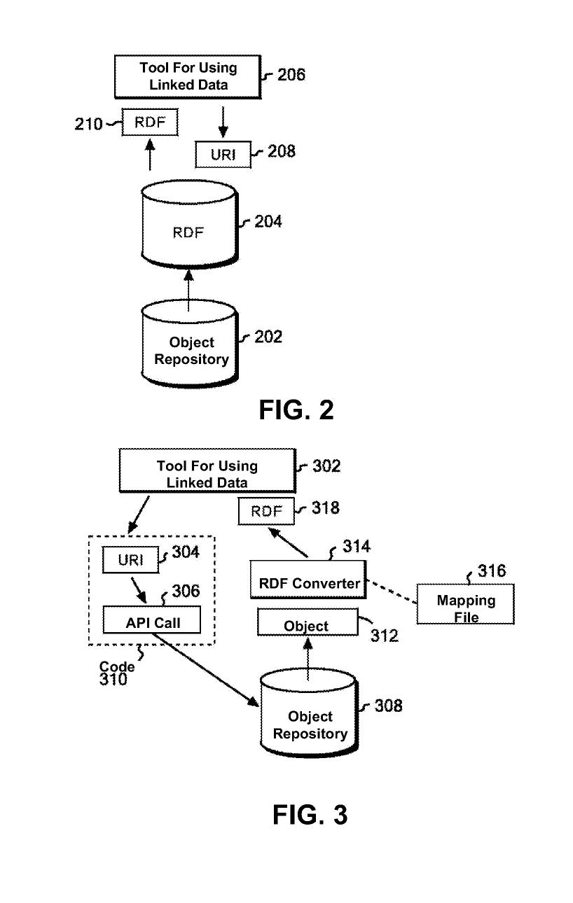

The functions of the present invention in FIG. 1 correspond to those of a tool for storing and providing linked data, which is accessed by a tool using linked data to convert non-RDF data to RDF.

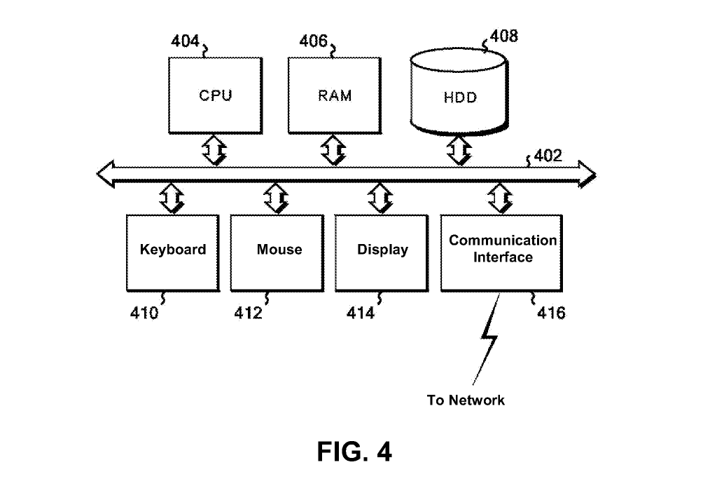

FIG. 4 is a block diagram of an example of hardware used to embody the present invention.

In FIG. 4, a CPU 404, main memory (RAM) 406, a hard disk drive (HDD) 408, a keyboard 410, a mouse 412, and a display 414 are connected to a system bus 402. The CPU 404 is preferably based on 32-bit or 64-bit architecture. Examples that can be used include Pentium™ 4 from Intel Corporation, CORE™ 2DUO from Intel Corporation, and Athlon™ from Advanced Micro Devices, Inc. The main memory 406 preferably has a capacity of 4 GB or more, and more preferably a capacity of 8 GB or more.

An operating system is stored in the hard disk drive 408. The operating system can be any operating system compatible with the CPU 404. Examples include Linux™, Windows 7™, Windows XP™ and Windows Server 2003™ from Microsoft Corporation, and MacOS™ from Apple, Inc.

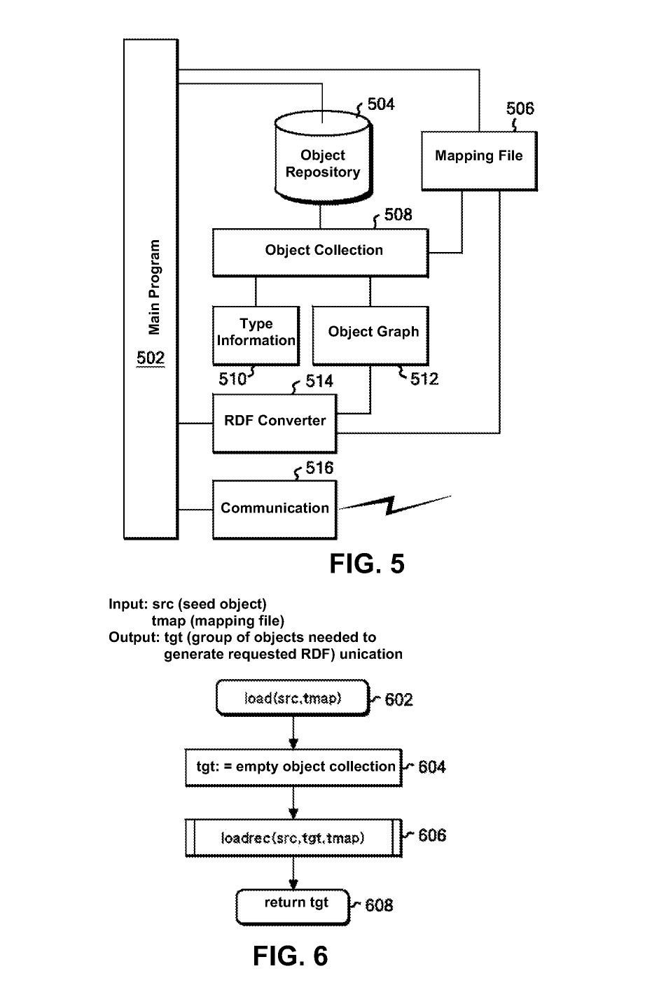

Also stored on the hard disk drive 408 and explained below with reference to FIG. 5 are a main program 502, object repository 504, mapping files 506, object collecting module 508, RDF converter 514, and communication module 516. A group of programs providing API for RDF conversion are also stored in the hard disk drive 408.

The main program 502 and the object collecting module 508 can be created by a compiler generating executable code compatible with the CPU 404 in an existing programming language such as C, C++ or Java®. The RDF converter 514 can be an existing program.

The object repository 504 and mapping files 506 do not have to be stored locally on the hard disk drive 408. They can also be stored remotely on a computer network drive.

The keyboard 410 and mouse 412 are used to manipulate graphic objects such as icons, task bars and text boxes displayed on the display 414 in accordance with the graphic user interface provided by the operating system.

There are no particular restrictions on the display 414. However, it is preferably a 32-bit true color LCD monitor with a resolution of 1024×768 or greater. The display 414 can be used, for example, to display a screen used to control the RDF conversion process.

The communication interface 416 is preferably connected to the network via the Ethernet® protocol. The communication interface 416 is used to receive requests from computers 116 with a tool using linked data, and to send RDF-converted data to computers 116 with a tool using linked data.

The following is an explanation with reference to FIG. 5 of the functional elements used to embody the present invention. In FIG. 5, the main program 502 includes functions for receiving via the communication module 516 URI from a computer 116 with a tool using linked data and starting the process, sending the results of the process via the communication module 516 to the computer 116 with a tool using linked data, and integrating all of the other processes.

The object repository 504 is stored locally or on a remote disk. The data for RDF conversion has a predetermined structure.

A mapping file 506 includes information indicating the RDF-compatibility of an object in the object repository 504. For example, if an object is expressed in XML and this is to be converted to RDF/XML, which is an XML expression of RDF, XSLT conversion is assumed. Therefore, an XSLT film is a mapping file. When the technology disclosed by the present applicant in Japanese Patent Application No. 2011-113456 is used, a mapping file includes a class diagram, which is meta information on the object, and information indicating correspondence with an RDF shape.

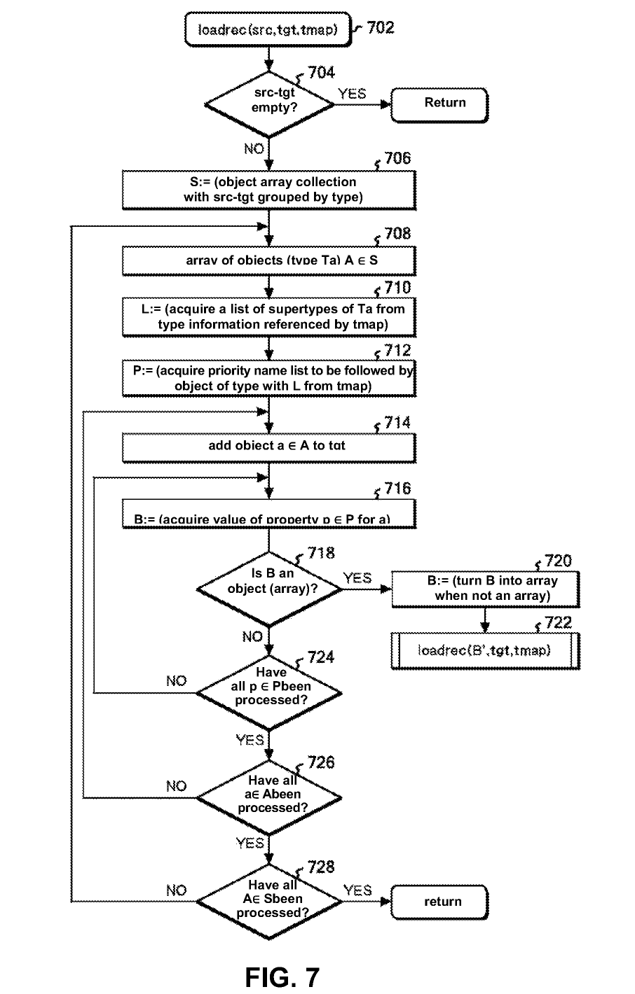

The object collecting module 508 begins processing in response to the main program 502 receiving a URI from a tool using linked data. The object collecting module 508 does not directly access the object repository 504 using the URI, but instead accesses all of the mapping files 506, extracts (some) type information 510, and stores this in the main memory 406 or hard disk drive 408. Next, the object collecting module 508 uses type information 510 to access the object repository 504, extracts the objects corresponding to the type information 510, and stores the objects as a graph 512 in the main memory 406 or the hard disk drive 408. The functions of the object collecting module 508 are explained in greater detail below with reference to the flowcharts in FIG. 6 and FIG. 7.

The RDF converter 514 does not have to be specific to the present invention. An existing RDF converter can be used. The RDF converter 514 uses information from mapping files 506 and an object graph 512 to generate an RDF file, and the main program 502 returns the RDF file to the tool using linked data that sent the URI.

The following is an explanation of the processing performed by the object collecting module 508 with reference to the flowcharts in FIG. 6 and FIG. 7. The object collecting module 508 inputs src (an object which will become a seed) and tmap (mapping file), and outputs tgt (an object group needed to generate the desired RDF). Here, the object which will become a seed is the type of object corresponding to the ID of the object which will become a seed as identified from the URI. For example, when the URI is http://www.sample1.com/AXZW, AXZW is designated as the ID of the object, and the object with this ID is the object which will become a seed.

FIG. 6 is a flowchart showing load(src, tmap), which is the main routine called up as the object collecting module 508.

When called up in Step 602, load(src, tmap) is set as the tgt:=empty object set in Step 604, and loadrec(src,tgt,tmap) is called up in Step 606. After loadrec(src,tgt,tmap) has been completed, tgt is returned in Step 608.

FIG. 7 is a flowchart showing the processing of load rec(src,tgt,tmap) called up by load(src, tmap).

When loadrec(src,tgt,tmap) is called up in Step 702, loadrec(src,tgt,tmap) determines whether src-tgt is empty in Step 704. If so, it is simply returned. This step is particularly meaningful when called up again in Step 722 as explained below.

If src-tgt is not empty, loadrec(src,tgt,tmap) is prepared in Step 706 as a set of object arrays in which src-tgt is grouped by type. This is set as S.

In Step 708, loadrec(src,tgt,tmap) selects one array A of objects (type Ta) in S. In other words, A S. It should be noted that the objects in the flowchart in FIG. 7 are objects in the object repository 504 loaded into the RAM 406.

In Step 710, loadrec(src,tgt,tmap) acquires the list of supertypes of Ta from the type information referenced by tmap, and this is called L.

In Step 712, loadrec(src,tgt,tmap) acquires a list of property names to follow the type of objects in L, we call it P.

In Step 714, loadrec(src,tgt,tmap) selects one element a in A, and this is added to tgt.

In Step 716, loadrec(src,tgt,tmap) acquires the value of property p P concerning a, and this is called B. At this time, for example, loadProperties(Object[],String[]) and getProperty(String) are called up. loadProperties(Object[],String[]) is the API function for loading the property listing in String[] concerning the object inside Object[] from the repository, and getProperty(String) is the API function taking the value of the property via the property name of the object.

In Step 718, loadrec(src,tgt,tmap) determines whether or not B is an object (array). If an object or its array, the process proceeds to Step 720. If an array, it is treated without change. If not an array, B is treated as an array. In other words, it is viewed as array B′ with a length of 1. In Step 722, loadrec(B′,tgt,tmap) is called up again.

If B is neither an object nor its array, loadrec(src,tgt,tmap) determines in Step 724 whether or not all of p P has been processed. If so, the process proceeds to Step 726. If not, the process returns to Step 716. After returning to Step 716, an unprocessed p P is selected from P and processed.

In Step 726, loadrec(src,tgt,tmap) determines whether or not all of a A have been processed. If so, the process proceeds to Step 728. If not, the process returns to Step 714. After returning to Step 714, any unprocessed a A is selected from A and processed.

In Step 728, loadrec(src,tgt,tmap) determines whether or not all A S have been processed. If so, the process is ended. If not, the process returns to Step 708. After returning to Step 708, any unprocessed A S is selected from S and processed.

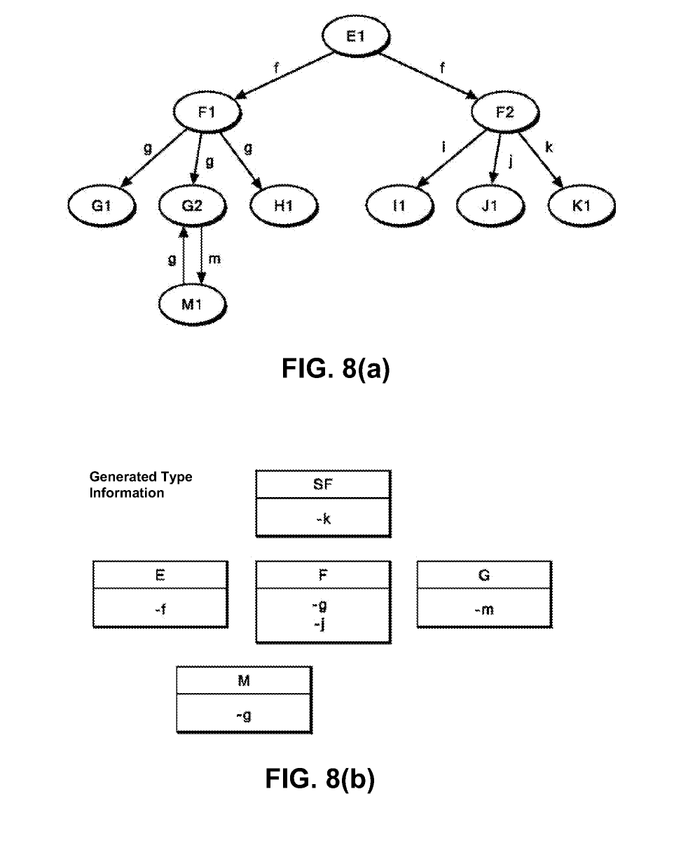

The following is a more detailed explanation of the processing in the flowchart of FIG. 7 with reference to FIG. 8. First, the notation will again be defined.
E, F, . . . =Type Name
f, g, . . . =Property Name
Object En, Fn, . . . =Type E, F, . . .
SF=Superclass of F
{A,B. . . }=Set
[A,B. . . ]=Array

The following is an explanation using these definitions and the example of a mapping file structure in FIG. 8 (a). Assuming the seed is E1, the object collecting module 508 has load([E1], tmap) call up loadrec([E1],{},tmap) (where tmap is the generated type information). Step 706 and Step 708 in FIG. 7 are hardly performed, and S={[E1]}.

In Step 710, L=[E] (no prioritized type). Step 712 references tmap for type E, and sets [f] as P.

Next, Step 714 enters E1 in tgt (tgt={E1}). Step 716 follows with f for E1, uses [F1,F2] as B′, and calls up loadrec([F1,F2],{E1},tmap).

As this process continues, it follows with g for F1, and G1, G2, H1 are taken. loadrec([G1,G2,H1],{E1,F1},tmap) is called up. Here, because of the different types (G and H), {[G1, G2],[H1]} is taken as S in Step 1.

G2 is followed by Ml, and then G2. However, because this is already in tgt, src-tgt={} is taken in Step 1. When loadrec is called up, the process immediately returns.

J1,K1 is taken for F2. This means what follows F is k in SF in addition to g, j.

Here, if that which becomes an array when there is no array is an object with a returned value of one, such as M1, J1 or K1, the array is [M1], [J1], [K1] because of the subsequent loadrec argument.

Finally, {E1, F1, F2, G1, G2, H1, M1, J1, K1} is entered into tgt(=following object), and this is returned by the load. Note that tgt is simply an object set. It maintains relationships, such as a given object referencing a given object. Thus, it can be said to be a graph of objects.

When the type information generated in this way is graphed, the result is shown in FIG. 8 (b).

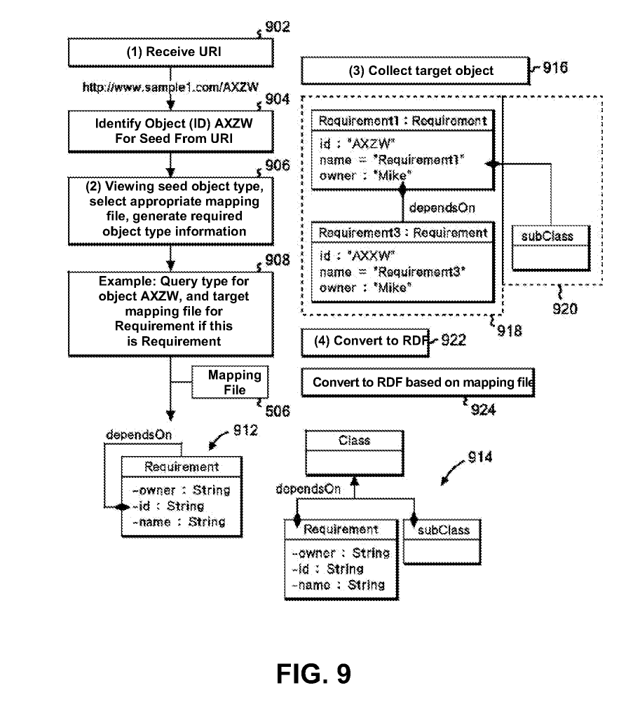

The following is an explanation of an example of the processing flow with reference to FIG. 9. First, in Step 902 in FIG. 9, main program 502 receives URI=http://www.sample1.com/AXZW from a tool using linked data via communication module 516.

The main program 502 uses this URI to call up the object collecting module 508. Thus, in Step 904, the object collecting module 508 identifies AXZW from the URI as the ID of the object which will become a seed.

In Step 906, the object collecting module 508 references the type of object to be the seed, selects the appropriate mapping file 506, and generates type information for the required objects. As indicated in comment frame 908, the type of object AXZW is queried. If this is Requirement, then the mapping file for Requirement is targeted.

The process explained in the flowcharts of FIG. 6 and FIG. 7 is performed, and the type information extracted from mapping file 506 is rendered schematically as indicated by reference number 912. The type information 912 is only a portion of the actual type 914. Here, the illustration has been simplified. There are actually several hundred properties with Requirement.

In Step 916, the object collecting module 508 calls up the API, and the object group indicated by reference number 918 is acquired from the object repository 504. When the API is called up, the type information 912 extracted from the mapping file is references, and only this is accessed. In other words, by using type information 912, which is partial type information, the portion for unrelated objects indicated by reference number 920 is not accessed.

Next, in Step 922, the RDF converter 516 converts the object group 918 to RDF. More specifically, as indicated in comment frame 924, the RDF converter 516 converts to RDF based on the mapping file.

The following is some of the RDF converted in this manner.

| | |
|---|---|
| <AXXW> | :name “Requirements3”; |
| | :owner“Mike”; |
| <AXZW> | :name“Requirements3”; |
| | :owner“Mike”; |
| | :dependsOn <AXXW3> |
| | ... ... |

In addition to the notation here, RDF can be expressed using another notation such as RDF/XML. Even so, the RDF converter applies the retrieved object group 918 to the mapping file in accordance with the graph expression to generate the resulting RDF.

The present invention was explained above with reference to specific embodiments. It should be clear to those skilled in the art that the present invention is not limited to a specific operating system or platform, but can be embodied in any computer system.

Also, the mapping files used in RDF conversion to not have to be XSLT. Any type can be used to map between objects and RDF.

We claim:

1. A computer implemented method for converting URI to RDF, comprising the steps of:
receiving a URI;
identifying an object to become a seed from the URI;
generating type information from the type of the object in a mapping file;
collecting the necessary objects from an object repository by referencing the generated type information;
passing the collected objects to an RDF converter; and
having the RDF converter reference the information of the mapping file to convert the collected objects to RDF.

2. The method according to claim 1, wherein the mapping file includes the pattern of the RDF to be generated, and the types, names, and property names of the objects needed for RDF generation.

3. The method according to claim 1, wherein the step for generating type information further comprises the steps of:
acquiring a prioritized list of the targeted type from type information referenced by the mapping file; and
acquiring a property name list for objects to follow in the mapping file in the prioritized list of the targeted type.

4. The method according to claim 1, wherein the object repository is XML files and the mapping file is XSLT.

5. A non-transitory computer readable storage medium tangibly embodying a computer readable program code having computer readable instructions which, when implemented, cause a computer to carry out the steps of a method for converting URI to RDF, the method comprising the steps of:
receiving a URI;
identifying an object to become a seed from the URI;
generating type information from the type of the object in a mapping file;
collecting the necessary objects from an object repository by referencing the generated type information;
passing the collected objects to an RDF converter; and
having the RDF converter reference the information of the mapping file to convert the collected objects to RDF.

6. The computer readable storage medium according to claim 5, wherein the mapping file includes the pattern of the RDF to be generated, and the types, names, and property names of the objects needed for RDF generation.

7. The computer readable storage medium according to claim 5, wherein the step for generating type information further comprises the steps of:
acquiring a prioritized list of the targeted type from type information referenced by the mapping file; and
acquiring a property name list for objects to follow in the mapping file in the prioritized list of the targeted type.

8. The computer readable storage medium according to claim 5, wherein the object repository is XML files and the mapping file is XSLT.

9. A computer implemented system for converting URI to RDF, comprising:
a storage means;
an object repository stored in the storage means;
a mapping file including a pattern of the RDF to be generated, and the types, names, and property names of the objects needed for RDF generation;
an RDF converter stored in the storage means;
means for receiving a URI and identifying an object to become a seed from the URI;
means for generating type information from the type of the object in a mapping file;
means for collecting the necessary objects from the object repository by referencing the generated type information; and
means in the RDF converter for referencing the information of the mapping file to convert the collected objects to RDF.

10. The system according to claim 9, wherein the means for generating type information further comprises:
means for acquiring a list of supertypes of the targeted type from type information referenced by the mapping file; and
means for acquiring a property name list for objects to follow in the mapping file in the list of supertypes of the targeted type.

11. The system according to claim 9, wherein the object repository is XML files and the mapping file is XSLT.
